(19) United States
(12) Patent Application Publication
(10) Pub. No.: US 2007/0278177 A1
(43) Pub. Date: Dec. 6, 2007

(54) Processing method using atomic force microscope microfabrication device

(76) Inventors: Kazushige Kondo, Chiba-shi (JP); Masatoshi Yasutake, Chiba-shi (JP); Takuya Nakaue, Chiba-shi (JP); Osamu Takaoka, Chiba-shi (JP); Atsushi Uemoto, Chiba-shi (JP); Kazutoshi Watanabe, Chiba-shi (JP); Yoshiteru Shikakura, Chiba-shi (JP)

Correspondence Address: BRINKS HOFER GILSON & LIONE, P.O. BOX 10395, CHICAGO, IL, 60610, US

(21) Appl. No.: 11/809,518

(22) Filed: Jun. 1, 2007

(30) Foreign Application Priority Data
Jun. 5, 2006 (JP) JP2006-155994

(51) Int. Cl. B44C 1/22; C03C 15/00; C03C 25/68

(52) U.S. Cl. 216/35

(57) ABSTRACT

Under the condition that the height is fixed at a target height by turning off a feedback control system of a Z piezoelectric actuator of a cantilever of an atomic force microscope having a probe, which is harder than a processed material, flexure and twisting of the cantilever when carrying out mechanical processing while selectively repeating scanning only on the processed area (in the case of detecting flexure, parallel with the cantilever and in the case of detecting twisting, vertical with the cantilever) is monitored by a quadrant photodiode position sensing detector and the processing is repeated till a flexure amount or a twisting amount, namely, till an elastic deformation amount of the cantilever becomes not more than a determined threshold. It is not necessary to carry out scanning of the observation in obtaining the height information for detection of an end point, so that it is possible to improve a throughput of processing.

This application claims priority under 35 U.S.C. §119 to Japanese Patent Application No. JP2006-155994 filed Jun. 5, 2006, the entire content of which is hereby incorporated by reference.

### BACKGROUND OF THE INVENTION

The present invention relates to a processing method using a microfabrication device applying an atomic force microscope technology.

For sophistication and high integration of a function, a microfabrication technology of a nanometer order has been required, and research and development of a processing method such as a local anodic oxidation and fine scratch processing using a scanned probe microscope (SPM) has been well practiced. In recent years, not only pursuit of a possibility of the fine processing but also an accurate shape and the process with a high precision as a practical processing device starts to be obtained.

In recent days, as an example that an accurate shape and high precision processing are required from an apparatus based on an atomic force microscope in practice, correction of a pattern opaque defect of a photomask may be considered (Y. Morikawa, H. Kokubo, M. Nishiguchi, N. Hayashi, R. White, R. Bozak, and L. Terrill, Proc. of SPIE 5130 520-527). The photomask opaque defect correction based on the atomic force microscope is practiced in such a manner that imaging is carried out in a contact mode or an intermittent contact mode of a normal atomic force microscope upon observation using an atomic force microscope probe which is harder than a present processed material (a material of an opaque defect) to identify a defect part, and feedback is turned off upon processing and a hard probe is fixed at the same height as a ground glass surface, and an opaque defect part on the glass surface is scanned to physically remove the opaque defect part. The photomask opaque defect correction based on the atomic force microscope is capable of correcting an isolated defect which is hardly observed and processed due to charging up by a focusing ion beam defect correcting device which has been used conventionally as a correcting device for a microscopic defect of a mask, so that the photomask opaque defect correction starts to be used in a mask manufacturing field in recent days. Since a mask is an original plate of wafer transcription, when a machining accuracy of the corrected portion is not good and an over-etched portion and an untrimmed portion are left, a transcription property is deteriorated so as to cause device defects in the all transcribed wafers. Therefore, in a mechanical removing process based on the atomic force microscope, an accurate shape and the processing with a high precision are needed.

Conventionally, according to a correcting device of a pattern opaque defect of a photomask based on the atomic force microscope, after observing an area including the opaque defect and determining a process area (an opaque defect area), a removing process in which opaque trimming is prevented and observation for obtaining height information are alternately carried out, and a next removing process of only the untrimmed portion except for the area attaining to the glass surface is repeated so as to reduce over-etching and the untrimmed portion as much as possible. In some cases, a time for observation in order to obtain the height information of the processed area may be longer than a time for processing and it takes a long time for correction since process and observation are repeated in many times, resulting in lowering a throughput (for example, JP-A-2005-266650 (P. 2, Second Column)).

The present invention has been made taking the foregoing problems into consideration and an object of which is to realize a high throughput of a removing process without over-etching and an untrimmed portion according to a processing method using a microfabrication device using an atomic force microscope technology.

### SUMMARY OF THE INVENTION

In order to solve the above-described object, according to a processing method for removing a processed area which exists on a planar substrate as a bulge by using an atomic force microscope microfabrication device having a probe which is harder than a processed material, under the condition that a height of a base of a cantilever is fixed at a target height, by scanning the cantilever in a planar direction and scanning a probe disposed at an end portion of the cantilever in a planar direction, removing processing is selectively repeated on the processed area, monitoring an elastic modification amount of the cantilever when carrying out the removing processing is carried out, and an end point of the processing is detected from the elastic modification amount.

For example, the target height is a height at which the probe contacts the planar substrate under the condition that the cantilever is not elastically deformed. In this time, when the processed material is left for the target height, a front end of a probe disposed on the end portion of a cantilever crashes against the processed material when scanning the cantilever in a planar direction, so that the cantilever is elastically deformed and this elastic deformation amount is increased. When the processed material is processed up to the target height, the front end of the probe does not crash against the processed material when scanning the cantilever in a planar direction, so that the elastic deformation amount is not increased.

In this case, the planar direction is to be a length direction of the cantilever or is to be a width direction of the cantilever. In the case that the planar direction is a length direction of the cantilever, the elastic deformation amount is a flexure amount of the cantilever, and in the case that the planar direction is a width direction of the cantilever, the elastic deformation amount is a twisting amount of the cantilever.

In addition, by obtaining the elastic deformation amount of the cantilever upon processing at a predetermined position in a planar direction, the cantilever is two-dimensionally monitored, and the area where the elastic deformation amount becomes not more than a determined threshold is assumed to be an end point of processing. Then, in a next process, the removing process is continued in a processing area except for the area attaining to the end point. The removing processing is repeated till the processing area entirely becomes the end point so as not to have the untrimmed portion.

Further, in order to shorten a total processing time by decreasing the number of processing till the area attains to the end point, obtaining a two-dimensional distribution of the elastic deformation amount which is detected upon processing and carrying out the removing processing by controlling the determined processing height in the next time in response to the volume of the elastic deformation, the cantilever is fixed at the target height again, the processing is carried out, and detection of the end point of the processing is repeated.

Since the end point of the processing is detected based on the elastic deformation amount of the cantilever upon processing, it is not necessary to carry out scanning of observation in order to obtain the height information, so that it is possible to shorten the total processing time.

When the removing processing is carried out by two-dimensionally controlling the determined process height in the next time in response to the volume of flexure or twisting, the processing amount of the area where flexure or twisting is large is large and the area where flexure or twisting is small can not trimmed much. Therefore, the number of processing can be decreased till the area attains to the end point in comparison with the case of continuing the processing at the target height.

### BRIEF DESCRIPTION OF THE DRAWINGS

FIG. 1A and FIG. 1B are views explaining the case of detecting an end point by a flexure amount of a cantilever upon processing. FIG. 1A is the case that the area does not attain to the end point of the processing, and FIG. 1B is the case that the area attains to the end point of the processing.

FIGS. 2A and 2B are views explaining the case of detecting an end point by a flexure amount of a cantilever upon processing. FIG. 1A is the case that the area does not attain to the end point of the processing, and FIG. 1B is the case that the area attains to the end point of the processing.

FIG. 3 is a view explaining the case of changing a next determined processing height in response to the volume of flexure from a flexure amount upon processing.

FIG. 4 is a view explaining the case of changing a next determined processing height in response to the volume of twisting from a twisting amount upon processing.

### DETAILED DESCRIPTION OF THE PREFERRED EMBODIMENT

Hereinafter, the embodiment of the present invention will be described in detail with reference to the drawing taking a correction of an opaque defect of a photomask as an example. The present invention is naturally applied to a correction of an opaque defect (a quartz bump defect) of alternating aperture phase shift photomask (Shibuya-Revenson type phase-shifting mask).

Introducing a photomask having an opaque defect found by a defect inspection of a defect inspection device into an atomic force microscope microfabrication device having a probe (for example, a probe made of diamond) which is harder than the processed material, a high precision XY stage is moved to the position where the opaque defect is found. Upon observation, under the condition of feed backing of Z piezoelectric actuator with a flexure amount of a cantilever, the area including the opaque defect is imaged in a contact mode or an intermittent contact mode of a normal atomic force microscope. Comparing the obtained image with a normal pattern without a defect by pattern matching or the like, the defect portion needing the processing is extracted to be identified.

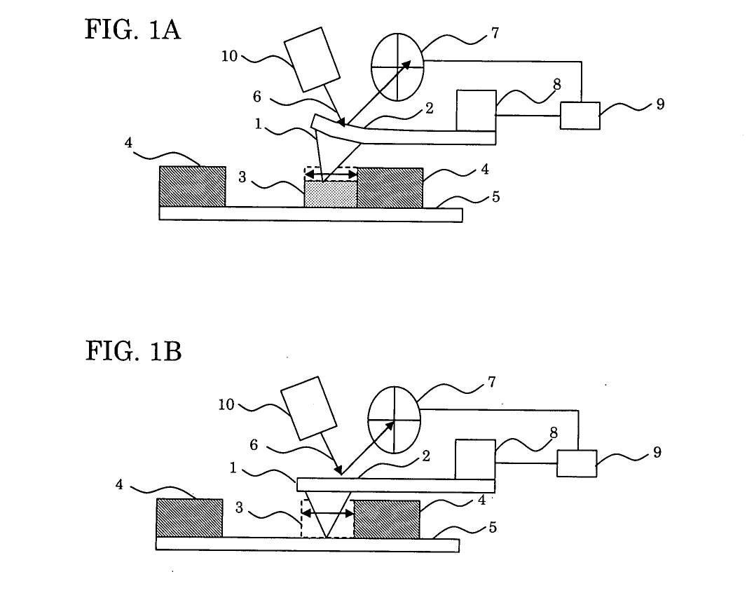

FIGS. 1A and 1B are views explaining the case of detecting an end point by a flexure amount of a cantilever upon processing. Then, this embodiment shows the case that the flexure amount is detected by a quadrant photodiode position sensing detector in an optical lever system.

A laser beam 6, which is emitted from a laser light source 10 and reflected on a rear surface of a cantilever 2 on the portion where a probe 1 is disposed, is controlled so as to strike a center of a quadrant photodiode position sensing detector 7 when there is no flexure on the cantilever 2. In the case that there is flexure on the cantilever 2, the laser beam 6 strikes the position deviated from the center of the quadrant photodiode position sensing detector 7, so that it is possible to detect if there is flexure or not by checking the output of the quadrant photodiode position sensing detector 7. In addition, it is also possible to estimate the flexure amount from a deviation amount from the center of the quadrant photodiode position sensing detector 7 of the laser beam 6 which is reflected on the rear surface of the cantilever 2.

Upon processing, a feedback control system 9 of a Z piezoelectric actuator 8, on the lower end of which the base of the cantilever 2 is fixed, is turned off. Moving the lower end of the Z piezoelectric actuator 8 in a Z direction by a predetermined amount, the base of the cantilever 2 is on the target level. Under the condition that the level of the base of the cantilever 2 is fixed, selectively repeating scanning of an opaque defect 3 of a light-resistant film 4 in a length direction of the cantilever 2, the defect is removed by mechanical processing. The target height is finally the height at which the front end of the probe 1 contacts a glass surface 5 in a binary mask and a half tone type phase shift mask, and is the height at which the probe 1 contacts the glass surface, which is a reference, in the case of a Levenson type phase shift mask. In the case that over-etching is generated by suddenly designating the target height of processing as the height of the glass surface, the removing processing is carried out while gradually lowering the target height till the area attains to the height of the glass surface step-by-step. In the case that the processed material (the opaque defect 3) is left for the target height while synchronizing the detected flexure amount of the cantilever 2 upon processing with scanning and two-dimensionally monitoring it in a planar direction, the front end of the probe 1 crashes against the processed material (the opaque defect 3) when scanning in the length direction of the cantilever 2, so that the cantilever 2 is flexed and the detected flexure amount is increased (FIG. 1A). In the case that the processed material is processed up to the target height, the front end of the probe 1 does not crash against the processed material (the opaque defect 3) when scanning in the length direction of the cantilever 2, so that the flexure amount is not increased (FIG. 1B). Assuming the area where the flexure amount is not more than the determined threshold as the end point of processing, in the next processing, the removing process is continued in the processing area except for the area that attains to the end point. In order not to have the untrimmed portion, the removing process is repeated till the all identified defect areas become the end points (finally, the glass surface 5 or the glass surface which is the reference) so as to completely remove defects for correction.

In the above description, the case of detecting the flexure amount of the cantilever 2 by the quadrant photodiode position sensing detector in an optical lever system upon processing is explained, however, the end point can be detected by the detection of the flexure amount using any of change of the piezoelectric actuator resistance in a self detection system and change of a distance in an optical interferometer system.

According to the example shown in the above-described FIGS. 1A and 1B, since the detection of the end point of the process is carried out depending on the flexure amount of the cantilever 2 upon processing, it is not necessary to carry out scanning for the observation in order to obtain the height information taking a long time in the middle of the processing. Therefore, it is possible to improve the throughput of the defect correction.

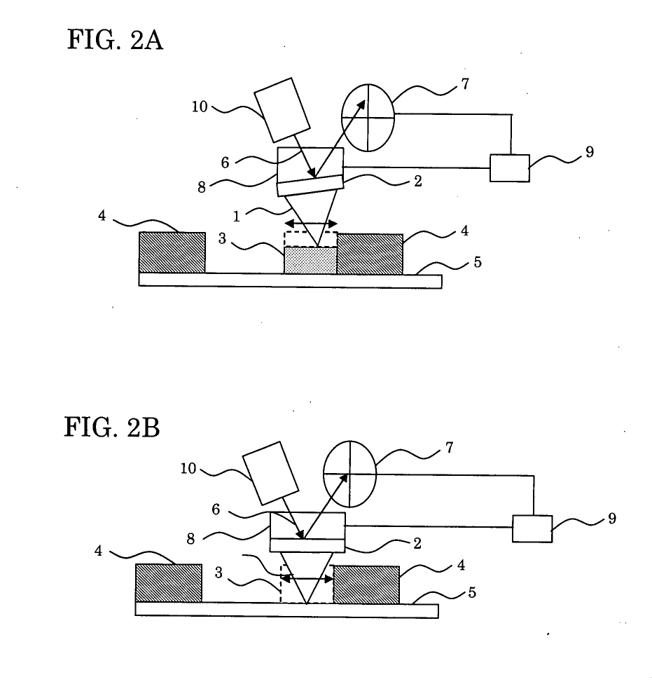

FIGS. 2A and 2B are views explaining the case of detecting an end point of process by a flexure amount of a cantilever upon processing. Then, this embodiment shows the case that the flexure amount is detected by a quadrant photodiode position sensing detector in an optical lever system. Also in the case that there is twisting on the cantilever 2, the laser beam 6 strikes the position deviated from the center of the quadrant photodiode position sensing detector 7, so that it is possible to detect if there is twisting or not by checking the output of the quadrant photodiode position sensing detector 7.

In this case, by scanning the probe 1 in the width direction of the cantilever 2, the defect is removed by the mechanical processing. Since scanning is carried out in the width direction, twisting is generated on the end portion of the cantilever 2 to be detected as an elastic change amount. In other words, in the case that the processed material (the opaque defect 3) is left for the target height, the front end of the probe 1 crashes against the processed material (the opaque defect 3) when scanning in the width direction of the cantilever 2, so that the cantilever 2 is twisted and the twisting amount to be detected is increased (FIG. 2A). In the case that the processed material is processed up to the target height, the front end of the probe 1 does not crash against the processed material (the opaque defect 3) when scanning, so that the twisting amount is not increased (FIG. 2B). Therefore, assuming the area where the flexure amount is not more than the determined threshold as the end point of processing, in the next processing, the removing process is continued in the processing area except for the area that attains to the end point.

In the above processing, since the end point of the processing is detected by the twisting amount of the cantilever 2 upon processing, it is not necessary to carry out scanning of observation, which takes a long time for obtaining the height information in the middle of the processing. Therefore, a time taken for defect correction can be shortened and the throughput can be improved.

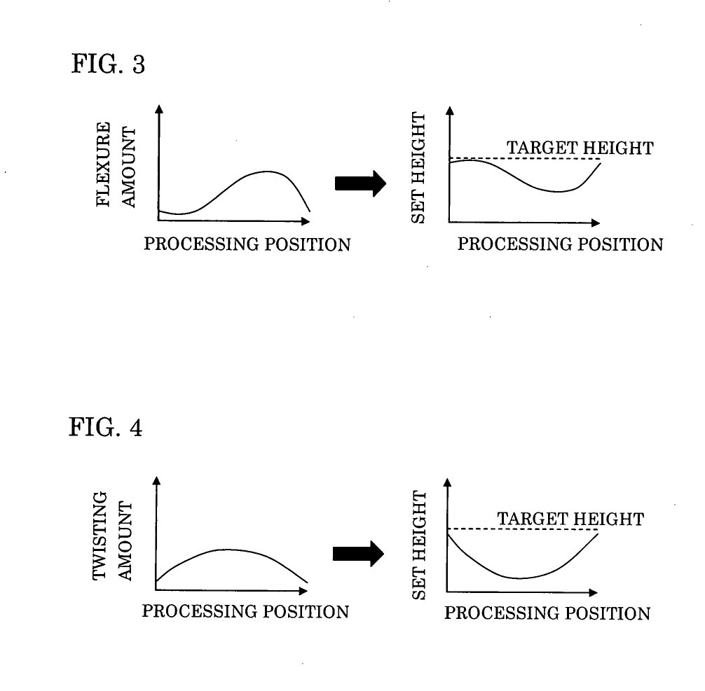

In order to decrease the number of processing till the area attains to the end point in the detection of the end point using the above-described flexure amount which is explained with reference to FIGS. 1A and 1B, as shown in FIG. 3, a two-dimensional distribution of the flexure amount of the cantilever 2 which is detected upon the processing of the defect is obtained and in response to the volume of the flexure, by two-dimensionally controlling the next determined processing height (on the area where the flexure amount is large, the determined processing height is lowered), the removing processing is carried out, and then, by repeating detection of the end point of the processing by performing the processing at the target height again, the processing amount is large since the processing height is lowered than the target height on the area where the flexure amount is large and the area where the flexure amount is small is not trimmed so much because the height of this area is near to the target height. As a result, the number of processing till the area attains to the end point (finally, the glass surface or the glass surface, which is a reference) can be reduced in comparison with the case that the processing is continued as the target height is remained, so that a total time for correction of a defect can be made shorter.

Also in the case of detecting the twisting amount, which is described with reference to FIGS. 2A and 2B, as shown in FIG. 4, by obtaining the two-dimensional distribution of the twisting amount of the cantilever 2 upon processing and two-dimensionally controlling the next determined processing height in response to the volume of the twisting (on the area where the flexure amount is large, the determined processing height is lowered), the removing processing is carried out, and then, by repeating detection of the end point of the processing by performing the processing at the target height again, the processing amount is large since the processing height is lowered than the target height on the area where the twisting amount is large and the area where the twisting amount is small is not trimmed so much because the height of this area is near to the target height. As a result, the number of processing till the area attains to the end point (finally, the glass surface or the glass surface, which is a reference) can be reduced in comparison with the case that the processing is continued as the target height is remained, so that a total time for correction of a defect can be made shorter.

The present invention is described taking an opaque defect removal of the photomask as an example, however, the same method can be applied to not only processing of the defect correction of the photomask but also the processing which requires accuracy in the height direction and uniformity of the processed bottom face.

What is claimed is:

1. A processing method for removing a processed area which exists on a planar substrate as a bulge by using an atomic force microscope microfabrication device having a probe which is harder than a processed material, comprising the steps of:
removing the processed area by scanning the cantilever in a planar direction and thereby scanning a probe that is disposed at an end portion of the cantilever in a planar direction on the processed area repetitively under the condition that a height of a base of a cantilever is fixed at a target height;
monitoring an elastic modification amount of the cantilever when removing the processed area; and
detecting an end point of the processed area from the elastic modification amount.

2. The processing method using the atomic force microscope microfabrication device according to claim 1, wherein the target height is a height at which the probe contacts the planar substrate under the condition that the cantilever is not elastically deformed.

3. The processing method using the atomic force microscope microfabrication device according to claim 1, wherein the planar direction is a length direction of the cantilever and the elastic deformation amount is a flexure amount of the cantilever.

4. The processing method using the atomic force microscope microfabrication device according to claim 1, wherein the planar direction is a width direction of the cantilever and the elastic deformation amount is a twisting amount of the cantilever.

5. The processing method using the atomic force microscope microfabrication device according to claim 1, wherein the end point of the processed area is detected by repeating the steps of:
controlling a next process height distribution in response to a two-dimensional distribution in a planar direction of the elastic deformation amount; and monitoring the elastic deformation amount of the cantilever upon the processing in which a height is fixed at the next process height again.

6. The processing method using the atomic force microscope microfabrication device according to claim 1, wherein
an optical lever system is used to detect the elastic deformation amount.

7. The processing method using the atomic force microscope microfabrication device according to claim 1, wherein
a self detection system is used to detect the elastic deformation amount.

8. The processing method using the atomic force microscope microfabrication device according to claim 6, wherein in the optical lever system, the detection of the elastic deformation amount is carried out by using a different value of a photo detector having detecting portion divided in quarters, the photo detector detecting light to be reflected by the cantilever.
